(19) United States
(12) Patent Application Publication
(10) Pub. No.: US 2011/0318465 A1
(43) Pub. Date: Dec. 29, 2011

(54) EFFERVESCENT CARRIER, A METHOD OF CHANGING THE FLAVOR OF MILK AND AN EFFERVESCENT TABLET FOR CHANGING THE FLAVOR OF MILK

(75) Inventor: Laknath Anslem Gootenilleke, Plymouth, MN (US)

(73) Assignee: Amerilab Technologies, Inc., Plymouth, MN (US)

(21) Appl. No.: 13/092,785

(22) Filed: Apr. 22, 2011

Related U.S. Application Data
(60) Provisional application No. 61/326,975, filed on Apr. 22, 2010.
(60) Provisional application No. 61/326,978, filed on Apr. 22, 2010.
(60) Provisional application No. 61/326,981, filed on Apr. 22, 2010.

(51) Int. Cl. A23L 2/40

(52) U.S. Cl. 426/540; 426/561

(57) ABSTRACT

An effervescent tablet that includes an effervescent agent that includes an acid component selected from the group consisting of an acid salt, an acid anhydride, and combinations thereof, and a base, binder, and lubricant, the effervescent tablet disintegrating when placed in milk to form a milk beverage that is free of noticeable curdling.

### CROSS-REFERENCE TO RELATED APPLICATIONS

This application claims priority to U.S. Provisional Application Ser. No. 61/326,975, filed on Apr. 22, 2010, U.S. Provisional Application Ser. No. 61/326,978, filed on Apr. 22, 2010, and U.S. Provisional Application Ser. No. 61/326,981, filed on Apr. 22, 2010, all of which are incorporated herein.

### BACKGROUND

The invention is directed to using effervescent compositions with milk.

Effervescent compositions are often added to a glass of water to make a beverage or to bath water to make a soothing bath. Effervescent compositions traditionally are formulated to include an effervescent couple that includes an acid and a base. The effervescent couple is activated when the effervescent composition is placed in water. The water liberates the acid and base and enables the acid and base to react with each other to produce carbon dioxide gas, which imparts carbonation to an aqueous composition.

Doctors often advise people to drink more milk. However, not everyone enjoys the taste of milk.

### SUMMARY

In one aspect, the invention features an effervescent tablet that includes an effervescent agent that includes an acid component selected from the group consisting of an acid salt, an acid anhydride, and combinations thereof, and a base, binder, and lubricant, the effervescent tablet, when placed in milk, disintegrates to form a milk beverage that is free of noticeable curdling. In some embodiments, the tablet has a hardness of at least 3 kiloponds. In one embodiment, the tablet further includes a flavor agent. In some embodiments, the effervescent tablet includes a flavor agent and disintegrates when placed in milk to form a flavored milk beverage that is free of noticeable curdling. In some embodiments, the flavor agent includes at least one of strawberry, chocolate, and vanilla. In other embodiments, the tablet disintegrates in milk having a temperature of less than 50° F. in less than 500 seconds.

In other embodiments, the acid component is selected from the group consisting of monopotassium phosphate, monocalcium phosphate, potassium bitartrate, acid citrate salt, sodium dihydrogen phosphate, D-glucurono lactone, and combinations thereof. In other embodiments, the effervescent tablet is free of citric acid, tartaric acid, ascorbic acid, fumaric acid, malic acid, and adipic acid.

In other embodiments, the acid component includes monopotassium phosphate.

In one embodiment, the tablet further includes defatted chocolate.

In some embodiments, the tablet further includes wheat germ oil.

In some embodiments, the tablet further includes a color agent that includes a mixture of red, yellow and blue dyes. In other embodiments, the color agent includes a mixture of FD&C number 40 red dye, FD&C number 5 yellow dye and FD&C 1 blue dye.

In another aspect, the invention features a method of changing the flavor of milk, the method including combining an effervescent tablet and milk, the effervescent tablet including an effervescent agent that includes an acid component selected from the group consisting of an acid salt, an acid anhydride, and combinations thereof, and a base, a flavor agent, binder, and lubricant, and allowing the tablet to disintegrate in the milk to form a flavored milk beverage that is free of noticeable curdling. In one embodiment, the milk has a temperature of no greater than 50° F. during the combining. In other embodiments, the milk has a temperature of at least 100° F. during the combining. In some embodiments, the acid component includes monopotassium phosphate. In another embodiment, the tablet is free of citric acid, tartaric acid, ascorbic acid, fumaric acid, malic acid, and adipic acid.

In other aspects, the effervescent tablet disintegrates in water to form water that is tasteless. In one embodiment, the tablet includes a tasteless vehicle that includes a base and an acid component selected from the group consisting of monopotassium phosphate, monocalcium phosphate, potassium bitartrate, acid citrate salt, sodium dihydrogen phosphate, and combinations thereof. In some embodiments, the base is selected from the group consisting of potassium carbonate, potassium bicarbonate, calcium carbonate, magnesium carbonate, zinc carbonate, and combinations thereof. In another embodiment, the tablet is used in a method of making tasteless water and the method includes combining an effervescent tablet that includes the effervescent vehicle with water and allowing the tablet to disintegrate in the water to form tasteless water.

In another aspect, the tablet includes a creamer that includes a milk component, and the tablet, when placed in a hot aqueous beverage, disintegrates to form a beverage that is free of noticeable coagulation. In one embodiment, the creamer further includes at least one of hydrogenated coconut oil, sodium caseinate, stearoyl lactylate, and soy lecithin.

In other aspects, the invention features a method of providing a creamer to a hot beverage, the method including combining an effervescent tablet that includes a creamer that includes a milk component with a hot beverage, allowing the tablet to disintegrate, the resulting beverage being free of noticeable coagulation. In one embodiment, the hot beverage is coffee, tea, milk or a combination thereof.

The effervescent composition provides a convenient way to add an effervescent composition to milk without causing noticeable curdling of the milk.

The effervescent tablet provides a convenient way to change the flavor of milk without causing noticeable curdling of the milk.

The effervescent tablet can also be formulated to provide a convenient way to add cream to a hot beverage without causing noticeable coagulation.

Other features and advantages will be apparent from the following description of the preferred embodiments and from the claims.

### GLOSSARY

The term “tasteless vehicle” means the vehicle does not impart taste to water when dissolved in water.

### DETAILED DESCRIPTION

The present inventor has discovered that adding a traditional effervescent composition to milk will cause the milk to curdle. The present inventor surmises that the acid present in the effervescent couple of the effervescent composition causes this curdling. The effervescent composition disclosed herein readily dissolves in milk without causing the milk to noticeably curdle, or even without causing any curdling of the milk. The effervescent composition can also be formulated to readily dissolve in cold milk (e.g., milk at a temperature of less than about 50 F, or even less than about 45 F), without causing the milk to noticeably curdle, or even without causing any curdling of the milk.

The effervescent composition includes an acid component that includes at least one of an acid salt and an acid anhydride, a base, and optionally a flavor agent. The effervescent composition disintegrates when placed in milk (e.g., cold milk) to provide a tasty, flavored beverage that is free of curdling. The acid component is selected to enable the effervescent composition to be placed in milk without curdling the milk. Useful acid salts include, e.g., monopotassium phosphate, monocalcium phosphate, potassium bitartrate, acid citrate salts, disodium hydrogen citrate, sodium dihydrogen phosphate, and combinations thereof. One example of a useful acid anhydride is D-glucurono lactone. The acid component is present in the effervescent composition in an amount of at least about 30% by weight, at least about 35% by weight, at least about 37% by weight, from about 30% by weight to about 50% by weight, from about 35% by weight to about 45% by weight, or even from about 37% by weight to about 42% by weight.

The effervescent composition preferably is free of acid including, e.g., citric acid, tartaric acid, ascorbic acid, fumaric acid, malic acid, and adipic acid.

The base preferably is capable of generating carbon dioxide. Suitable carbonate bases include, e.g., potassium carbonate, potassium bicarbonate, calcium carbonate, magnesium carbonate, zinc carbonate, sodium carbonate and sodium bicarbonate, and mixtures thereof. The effervescent composition preferably includes from about 20% by weight to about 45% by weight, from about 25% by weight to about 40% by weight, or even from about 30% by weight to about 38% by weight base.

The acid component and the base form the effervescent agent, which is also referred to herein as the effervescent couple. The effervescent composition preferably includes from about 50% by weight to about 95% by weight, from about 60% by weight to about 90% by weight, from about 65% by weight to about 85% by weight, or even from about 70% by weight to about 80% by weight effervescent agent.

The effervescent composition optionally includes a flavor agent, which can impart a flavor to the milk. A variety of flavor agents can be used to impart a variety of flavors to the milk including such flavors as coffee, chocolate (e.g., defatted chocolate), vanilla, hazelnut, peanut butter, butter, caramel, crème de menthe, mint (e.g., spearmint and peppermint), cinnamon, clove, nutmeg, almond, lemon, orange, grape, lime, grapefruit, apple, pear, peach, strawberry, raspberry, cherry, plum, pineapple, apricot, and combinations thereof. Suitable flavor agents include natural and synthetic flavoring sources including, e.g., volatile oils, synthetic flavor oils, flavoring aromatics, oils, liquids, oleoresins and extracts derived from plants, leaves, flowers, fruits, stems and combinations thereof. Specific examples of flavor agents include citric oils, e.g., lemon, orange, grape, lime and grapefruit, fruit essences including, e.g., apple, pear, peach, grape, strawberry, raspberry, cherry, plum, pineapple, apricot, and other fruit flavors. Other useful flavor agents include, e.g., aldehydes and esters (e.g., benzaldehyde (cherry, almond)), citral, i.e., alpha-citral (lemon, lime), neral, i.e., beta-citral (lemon, lime), decanal (orange, lemon), aldehyde C-8 (citrus fruits), aldehyde C-9 (citrus fruits), aldehyde C-12 (citrus fruits), tolyl aldehyde (cherry, almond), 2,6-dimethyloctanal (green fruit), 2-dodedenal (citrus, mandarin) and mixtures thereof. The effervescent composition preferably includes at least about 1% by weight, from about 1% by weight to about 25% by weight, from about 2% by weight to about 20% by weight, or even from about 5% by weight to about 15% by weight flavor agent.

The effervescent composition optionally includes a color agent. The color agent can be any color agent suitable for imparting color to milk. Useful color agents include, e.g., dyes, pigments, and combinations thereof. Examples of useful color agents include, e.g., food, drug and cosmetic (FD&C) colors including, e.g., dyes, lakes, and certain natural and derived colorants. Useful lakes include dyes absorbed on aluminum hydroxide and other suitable carriers. Examples of suitable color agents include FD&C Red No. 3, FD&C Red No. 40, FD&C Blue No. 1, FD&C Blue No. 2, FD&C Yellow No. 5, FD&C Yellow No. 6, FD&C Green No. 3, and combinations thereof. One example of a color agent for imparting a brown color to a beverage includes a combination of a red color agent (e.g., FD&C Red No. 40), a blue color agent (e.g., FD&C Blue No. 1 and FD&C Blue No. 2), and a yellow color agent (e.g., FD&C Yellow No. 5 and FD&C Yellow No. 6). The effervescent tablet includes any suitable amount of color agent. The effervescent tablet preferably includes at least about 0.1% by weight, from about 0.1% by weight to about 1.5% by weight, from about 0.1% by weight to about 1.0% by weight, or even from about 0.1% by weight to about 0.7% by weight color agent.

The effervescent composition can be in a variety of forms including, e.g., a granulation, powder, and tablet. Where the composition is in the form of a tablet, it preferably also includes binder, lubricant, and combinations thereof.

Examples of suitable binders include, e.g., starches, natural gums, cellulose gums, microcrystalline cellulose, methylcellulose, cellulose ethers, sodium carboxymethylcellulose, ethylcellulose, gelatin, dextrose, lactose, sucrose, sorbitol, mannitol, polyethylene glycol, polyvinylpyrrolidone, pectins, alginates, polyacrylamides, polyvinyloxoazolidone, polyvinylalcohols and mixtures thereof. One example of a useful commercially available binder is AVICEL microcrystalline cellulose from FMC Corporation (Philadelphia, Pa.).

The effervescent composition includes a sufficient amount of binder to assist in holding the components of the effervescent composition together in the form of a tablet. Preferably binder is present in the effervescent composition in an amount of from about 5% by weight to about 30% by weight, from about 10% by weight to about 25% by weight, or even from about 10% by weight to about 20% by weight.

Various lubricants are suitable for use in the effervescent composition including, e.g., water dispersible, water soluble, water insoluble lubricants and combinations thereof. Preferred lubricants are water soluble. Useful water soluble lubricants include, e.g., sodium benzoate, polyethylene glycol, L-leucine, adipic acid, and combinations thereof. The composition can also include water insoluble lubricants including, e.g., stearates (e.g., magnesium stearate, calcium stearate and zinc stearate), sodium stearyl fumarate, oils (e.g., mineral oil, wheat germ oil, hydrogenated and partially hydrogenated vegetable oils, and cotton seed oil) and combinations thereof. Other water insoluble lubricants include, e.g., animal fats, polyoxyethylene monostearate, talc, sodium lauryl sulphate, magnesium oxide and combinations thereof. Examples of commercially available binders include PRUV sodium stearyl fumarate from J. Rettenmaier & Sohne GmbH & Co. KG Johanna Rettenmaier (Germany)

The effervescent composition preferably includes a sufficient amount of lubricant to enable the effervescent composition to be formed into tablets and released from a high speed tableting press in the form of a tablet. The effervescent composition includes lubricant in an amount of at least 0.1% by weight, at least 0.2% by weight, from about 0.5% by weight to about 5% by weight, from about 0.5% by weight to about 4% by weight, or even from about 1.0% by weight to about 3% by weight.

The effervescent composition preferably includes a sweetening agent. Useful examples of sweetening agents can include sugars such as sucrose, glucose, invert sugar, fructose, sucralose, saccharin and its various salts (e.g., sodium and calcium salt of saccharin), cyclamic acid and its various salts, dipeptide sweeteners (e.g., aspartame), dihydrochalcone, glycyrrhizin, sugar alcohols including, e.g., sorbitol, sorbitol syrup, mannitol and xylitol, stevia, and combinations thereof. When present, the effervescent composition includes less than about 2% by weight, from about 0.05% by weight to about 1.5% by weight, or even from about 0.1% by weight to about 1% by weight sweetening agent.

The effervescent composition can also include of a variety of active agents including, e.g., vitamins, amino acids, pharmaceutical agents, minerals, dietary supplements, and combinations thereof. Examples of minerals include calcium, iron, zinc, selenium, copper, iodine, magnesium, phosphorus, chromium and mixtures thereof.

The effervescent composition can also include other ingredients including, e.g., fillers, surfactants (e.g., polysorbate 80 and sodium lauryl sulfate), emulsifiers (e.g., D-gluctose-6-phosphate), and combinations thereof.

The components of the effervescent composition are preferably dried and sieved as necessary prior to formulating. The effervescent composition preferably is uniform.

A beverage can be prepared from the effervescent composition by combining the effervescent composition with excess milk (e.g., adding the effervescent composition to milk or adding milk to the effervescent composition). In one useful method, the effervescent composition in the form of a tablet is added to a four ounce, six ounce or eight ounce glass of milk. After combining the effervescent composition and milk, the mixture can optionally can be stirred to facilitate dispersion and/or dissolution of the effervescent composition in the milk.

The effervescent composition can be added to milk that is at a variety of temperatures including a temperature of less than about 50° F., or even less than about 45° F. to make a flavored cold milk beverage, and to milk having a temperature of at least 100° F., at least 150° F., at least 175° F., or even at least 200° F. to make a hot beverage (e.g., hot chocolate).

The effervescent composition is well suited for use in the mass production of effervescent tablets that are free from picking, die wall etching, capping and lamination. Any suitable tablet mass production equipment and process can be used. Examples of useful tableting processes for effervescent compositions are described in Pharmaceutical Dosage Forms, Vol. 1 (Herbert A. Lieberman et al. eds, 2^{nd} ed. 1989) and incorporated herein. The tablets can be manufactured in an automated process in which multiple dies of a tablet press are filled sequentially or simultaneously with the effervescent composition, two punches compress the effervescent composition to form the tablet(s), and then the tablet(s) is ejected from the die.

The tablet manufacturing and initial packing operations are preferably performed in a controlled environment in which the temperature and humidity are controlled. Preferably the controlled environment has less than 18 grains, less than 16 grains, or even less than 15 grains of moisture.

Preferred effervescent tablets have a hardness of at least 1 kiloponds (Kp), at least 2.5 Kp, at least 4 Kp, from about 2 Kp to about 10 Kp, or even from about 5 Kp to about 8 Kp, as measured on a standard hardness tester fitted with a strain gauge.

The tablet is then placed in packaging material, which is then sealed to form an air tight sealed package. The effervescent composition is preferably stored in a moisture-proof package including, e.g., sealed metal foil pouches, blister packs, and desiccant capped tubes. Useful packaging materials further include metal foil, plastic films, and blister packaging.

The packaged tablet can be further processed by conveying it to other processing stations including, e.g., additional packaging stations for further packaging, e.g., boxing and bagging.

Other useful methods of making effervescent tablets are disclosed in Pharmaceutical Dosage Forms, Vols. 1-3, (Lieberman et al. eds. 2^{d} ed. 1989) and incorporated herein.

The invention will now be described by way of the following examples. All parts, ratios, percents, and amounts stated in the Examples are by weight unless otherwise specified.

### EXAMPLES

### Test Procedures

Test procedures used in the examples include the following. All ratios and percentages are by weight unless otherwise indicated.

### Curdling Test Method

The presence of noticeable curdling in a sample is determined by placing an effervescent tablet in six ounces of 2% milk at room temperature (i.e., about 72° C.), allowing the tablet to disintegrate, and observing the milk with the naked eye. If visible precipitate is present (e.g., on the sides of the vessel), then the milk is deemed to exhibit noticeable curdling. If no visible precipitate is present in the milk, then the milk is deemed to be free of noticeable curdling.

### Example 1

A uniform effervescent composition was prepared by blending with mixing the following ingredients: monopotassium phosphate, potassium carbonate, potassium bicarbonate, AVICEL microcrystalline cellulose (FMC Corporation, Philadelphia, Pa.), sodium benzoate, vanilla flavor (Mother Murphy's Laboratories, Inc., Greensboro, N.C.), sodium stearyl fumarate, wheat germ oil, acesulfame potassium, and sucralose in the amounts (in percent by weight) set forth in Table 1 below.

The ingredients were sieved through a 12 mesh screen as necessary. The granulation was then run on a Cadmach tableting press using 21 mm round stainless steel tools. The resulting tablets had an average mass of 2.71 grams (g), an average thickness of 0.198 inches (in) and an average hardness of 3.2 kp.

The tablets dissolved in 150 seconds when placed in from 4 ounces to 6 ounces of 48° F. 2% milk. The resulting beverage was free of curdling.

### Example 2

A uniform effervescent composition was prepared by blending with mixing the following ingredients: monopotassium phosphate, potassium carbonate, potassium bicarbonate, AVICEL microcrystalline cellulose (FMC Corporation, Philadelphia, Pa.), sodium benzoate, chocolate flavor (Nutraceuticals International, LLC, Elmwood Park, N.J.), sodium stearyl fumarate, wheat germ oil, acesulfame potassium, and sucralose in the amounts (in percent by weight) set forth in Table 1.

The ingredients were sieved through a 12 mesh screen as necessary. The granulation was then run on a Cadmach tableting press using 21 mm round stainless steel tools. The resulting tablets had an average mass of 2.79 g, an average thickness of 0.197 in and an average hardness of 3.6 kp.

The tablets dissolved in 480 seconds when placed in from 4 ounces to 6 ounces of 42.3° F. 2% milk. The resulting beverage was free of curdling.

### Example 3

A uniform effervescent composition was prepared by blending with mixing the following ingredients: monopotassium phosphate, potassium carbonate, potassium bicarbonate, AVICEL microcrystalline cellulose, sodium benzoate, Artificial Strawberry flavor, polyethylene glycol, acesulfame potassium, polyvinylpyrrolidone, 50% Carmine Powder color agent, and Sugar Ester S1170 F d-glucose-6-phosphate in the amounts (in percent by weight) set forth in Table 1.

The ingredients were sieved through a 12 mesh screen as necessary. The granulation was then run on a Cadmach tableting press using 21 mm round stainless steel tools. The resulting tablets had an average mass of 2.80 g, an average thickness of 0.218 in and an average hardness of 3.0 kp.

The tablets dissolved in from four to seven minutes, 20 seconds when placed in from 4 ounces to 6 ounces of 45° F. 2% milk. The resulting beverage was free of curdling.

### Example 4

A uniform effervescent composition was prepared by blending with mixing the following ingredients: monopotassium phosphate, potassium carbonate, potassium bicarbonate, sorbitol, sodium benzoate, defatted chocolate, chocolate flavor (Fona International, Geneva, Ill.), sodium stearyl fumarate, fumed silica, wheat germ oil, acesulfame potassium, Sensient color agent, and sucralose in the amounts (in percent by weight) set forth in Table 1.

The ingredients were sieved through a 12 mesh screen as necessary. The granulation was then run on a Cadmach tableting press using 21 mm round stainless steel tools. The resulting tablets had an average mass of 3.17 g, an average thickness of 0.244 in and an average hardness of 4.5 kp.

The tablets were placed in six ounces of 175° F. 2% milk and dissolved in 240 seconds to form a beverage that tasted like hot chocolate, had a good chocolate color, and was free of curdling.

### Control 1

A uniform effervescent composition was prepared by blending with mixing the following ingredients: citric acid, d-glucuronolactone, sodium carbonate, potassium bicarbonate, sorbitol, sodium benzoate, polyethylene glycol, polyvinylpyrrolidone, vanilla durarome (0.73% by weight), vanilla powder (3.63% by weight), acesulfame potassium, and sucralose in the amounts (in percent by weight) set forth in Table 1.

The ingredients were sieved through a 12 mesh screen as necessary. The granulation was then run on a Cadmach tableting press using 21 mm round stainless steel tools. The resulting tablets had an average mass of 2.79 g, an average thickness of 0.218 in and an average hardness of 3.3 kp.

The tablets were placed in six ounces of 2% milk at 40.15° F. and dissolved in 3 minutes 15 seconds. Visible precipitate was present after dissolution of the tablet.

TABLE 1

| | Ex- | | | | Control |
|---|---|---|---|---|---|
| Ingredient | ample 1 | Example 2 | Example 3 | Example 4 | 1 |
| Monopotassium | 40.531 | 39.711 | 39.08 | 35.02 | 0 |
| Phosphate | | | | | |
| Potassium | 3.685 | 3.610 | 3.55 | 3.18 | 0 |
| Carbonate | | | | | |
| Potassium | 29.477 | 28.881 | 28.42 | 25.47 | 29.06 |
| Bicarbonate | | | | | |
| Microcrystalline | 14.738 | 14.440 | 14.21 | 0 | 0 |
| Cellulose | | | | | |
| Sodium Benzoate | 1.105 | 1.083 | 1.78 | 0.96 | 1.82 |
| Flavor | 9.211 | 10.830 | 7.10 | 10.82 | 5.09 |
| Sodium Stearyl | 0.553 | 0.542 | 0.00 | 0.54 | 0 |
| Fumarate | | | | | |
| Wheat Germ Oil | 0.184 | 0.181 | 0.00 | 0.25 | 0 |
| Acesulfame | 0.368 | 0.542 | 0.53 | 0.48 | 0.91 |
| Potassium | | | | | |
| Sucralose | 0.147 | 0.181 | 0.14 | 0.25 | 0.29 |
| Polyvinyl | 0.000 | 0.000 | 2.84 | 0 | 0 |
| Pyrrolidone | | | | | |
| 2-Pyrrolidinone, | 0 | 0 | 0 | 0 | 0.54 |
| 1-Ethenyl, | | | | | |
| Homopolymer | | | | | |
| Color Agent | 0.000 | 0.000 | 0.21 | 0.48 | 0 |
| d-glucose-6- | 0.000 | 0.000 | 0.89 | 0 | 0 |
| phosphate | | | | | |
| Sorbitol | 0 | 0 | 0 | 15.92 | 14.53 |
| Fumed silica | 0 | 0 | 0 | 0.25 | 0 |
| Defatted | 0 | 0 | 0 | 6.37 | 0 |
| Chocolate | | | | | |
| Sodium | 0 | 0 | 0 | 0 | 3.63 |
| Carbonate | | | | | |
| D- | 0 | 0 | 0 | 0 | 29.06 |
| glucuronolactone | | | | | |
| Citric acid | 0 | 0 | 0 | 0 | 12.71 |
| Polyethylene | 0 | 0 | 0 | 0 | 2.18 |
| glycol | | | | | |

### Control 2

Adipic acid was placed in six ounces of 2% milk at about 40° F. The milk curdled as evidenced by a visible precipitate on the sides of the clear plastic cup when the milk was poured out of the cup.

### Control 3

Sodium acid sulfate was placed in six ounces of 2% milk at about 40° F. The milk curdled as evidenced by a visible precipitate on the sides of the clear plastic cup when the milk was poured out of the cup.

Other embodiments are within the claims. The present inventor has further discovered that the base effervescent formulation (i.e., the above-described effervescent agent, binder and lubricant) exhibits utility in a variety of other effervescent composition applications. In one embodiment, the effervescent composition includes the base effervescent formulation and a creamer that includes a milk component. The effervescent composition of this embodiment readily dissolves in hot aqueous beverages (e.g., coffee and tea having a temperature of at least about 80° F.), without causing noticeable coagulation, or even without causing any coagulation. The effervescent tablet provides a convenient way to add cream to a hot beverage without causing noticeable coagulation.

The creamer adds a component from milk to the hot beverage and preferably imparts creamy sensation to the mouth of the consumer when a consumer consumes a beverage prepared from the effervescent composition. Suitable creamers include a variety of components including, e.g., hydrogenated coconut oil, corn syrup solids, sodium caseinate, dipotassium phosphate, sugar, monoglycerides, diglycerides, sodium silicoaluminate, sodium stearoyl lactylate, soy lecithin, color agents, flavor agent, and combinations thereof. One useful creamer is commercially available under the 50% CUSTOM CRÈME 50205 trade designation from Bay Valley, LLC (Horsham, Pa.). Other useful creamers are also available from Bay Valley, LLC. The effervescent composition optionally includes at least 15% by weight, from about 15% by weight to about 35% by weight, or even from about 20% by weight to about 30% by weight creamer.

The effervescent composition of this embodiment includes from about 20% by weight to about 40% by weight, from about 25% by weight to about 35% by weight, or even from about 27% by weight to about 32% by weight of the acid component, from about 15% by weight to about 40% by weight, from about 20% by weight to about 35% by weight, or even from about 20% by weight to about 30% by weight base, and from about 40% by weight to about 95% by weight, from about 45% by weight to about 85% by weight, or even from about 50% by weight to about 75% by weight of the effervescent agent (i.e., the combined weight of the acid component and the base).

The effervescent composition of this embodiment can optionally include at least one of the optional components set forth above including, e.g., a flavor agent, a color agent, a sweetening agent, and combinations thereof.

A beverage can be prepared from the effervescent composition that includes the creamer by combining the effervescent composition with excess aqueous beverage, preferably a hot beverage (e.g., a beverage at a temperature of at least about 80° F.) (e.g., by adding the effervescent composition to coffee or tea or adding coffee or tea to the effervescent composition). In one useful method, the effervescent composition that includes the creamer is in the form of a tablet and is added to a six ounce cup of a hot beverage, e.g., coffee or tea. After combining the effervescent composition and the beverage, the mixture can optionally can be stirred to facilitate dispersion and/or dissolution of the effervescent composition in the beverage.

### Example 5

A uniform effervescent composition was prepared by blending with mixing the following ingredients: monopotassium phosphate, potassium carbonate, potassium bicarbonate, AVICEL microcrystalline cellulose, hazelnut flavor, wheat germ oil, acesulfame potassium, sucralose, and 50% CUSTOM CRÈME 50205 creamy taste agent (Bay Valley Foods, LLC, Horsham, Pa.) in the amounts (in percent by weight) set forth in Table 2. The 50% CUSTOM CREME 50205 creamy taste agent included hydrogenated coconut oil, corn syrup solids, sodium caseinate, dipotassium phosphate, sugar, monoglycerides, diglycerides, sodium silicoaluminate, sodium stearoyl lactylate, soy lecithin, color agents, and flavor agent.

The ingredients were sieved through a 12 mesh screen as necessary. The granulation was then run on a Cadmach tableting press using 21 mm round stainless steel tools. The resulting tablets had an average mass of 3.68 g, an average thickness of 0.229 in and an average hardness of 4 kp.

The tablets dissolved in 54 seconds when placed in 6 ounces of hot coffee. The resulting beverage was free of coagulation.

### Example 6

A uniform effervescent composition was prepared by blending with mixing the following ingredients: monopotassium phosphate, potassium carbonate, potassium bicarbonate, AVICEL microcrystalline cellulose, hazelnut flavor, wheat germ oil, acesulfame potassium, sucralose, sorbitol, and CREMER creamer (Bay Valley Foods, LLC) in the amounts (in percent by weight) set forth in Table 2.

The ingredients were sieved through a 12 mesh screen as necessary. The granulation was then run on a Cadmach tableting press using 21 mm round stainless steel tools. The resulting tablets had an average mass of 3.7 g, an average thickness of 0.230 in and an average hardness of 3.4 kp.

The tablets dissolved in 50 seconds when placed in 6 ounces of hot coffee. The resulting beverage was free of coagulation.

TABLE 2

| Ingredient | Example 5 | Example 6 |
|---|---|---|
| Monopotassium Phosphate | 29.18 | 29.18 |
| Potassium Carbonate | 2.65 | 2.65 |
| Potassium Bicarbonate | 21.22 | 21.22 |
| Microcrystalline Cellulose | 15.92 | 7.96 |
| Flavor | 3.18 | 3.18 |
| Acesulfame Potassium | 0.80 | .80 |
| Wheat Germ Oil | 0.40 | 0.40 |
| Sucralose | 0.13 | 0.13 |
| Sorbitol | 0.00 | 7.96 |
| Creamer | 26.53 | 26.53 |

In another embodiment, the effervescent composition is formulated to provide a tasteless effervescent vehicle. The tasteless effervescent vehicle can be used to disperse an active agent in water. The tasteless vehicle is also useful for delivering compounds that will render water potable, without imparting a flavor or taste to the water. The tasteless effervescent vehicle includes the effervescent agent, the binder and the lubricant described above. The tasteless effervescent vehicle disintegrates in water to form water that is tasteless.

The acid component of the effervescent formulation is selected such that it does not impart a tart taste to the water. Suitable acid components include those acid components set forth above. The acid component is preferably present in the effervescent composition of the tasteless vehicle in an amount of from about 10% by weight to about 50% by weight, from about 15% by weight to about 35% by weight, from about 20% by weight to about 30% by weight, or even from about 20% by weight to about 25% by weight.

Suitable bases include the bases set forth above and in particular, e.g., potassium carbonate, potassium bicarbonate, calcium carbonate, magnesium carbonate, zinc carbonate, sodium carbonate and sodium bicarbonate, and mixtures thereof. The base is preferably present in the effervescent composition of the tasteless vehicle in an amount of from about 5% by weight to about 30% by weight, from about 10% by weight to about 25% by weight, or even from about 10% by weight to about 20% by weight.

The effervescent composition of the tasteless vehicle preferably includes from about 30% by weight to about 75% by weight, from about 35% by weight to about 70% by weight, or even from about 40% by weight to about 55% by weight effervescent agent.

The tasteless vehicle optionally includes an active agent, e.g., a water purification component. Useful active agents include, e.g., those agents that render potable water from a fresh water source (e.g., a lake, pond, river, stream, marsh or swamp), vitamins, amino acids, pharmaceutical agents, minerals, dietary supplements, and combinations thereof. The effervescent composition optionally includes from about 10% by weight to about 75% by weight, from about 20% by weight to about 70% by weight, from about 30% by weight to about 60% by weight, or even from about 40% by weight to about 55% by weight active agent.

The effervescent composition optionally includes the optional components set forth above in the amounts set forth above including, e.g., color agents, flavor agents and sweetening agents.

In some embodiments, the tasteless vehicle is free of D-glucurono lactone, sodium acid pyrophosphate, acid (e.g., citric acid, tartaric acid, ascorbic acid, fumaric acid, malic acid, and adipic acid), sodium carbonate, sodium bicarbonate, and combinations thereof.

A beverage can be prepared from the effervescent composition by combining the effervescent composition with water (e.g., adding the effervescent composition to water or adding water to the effervescent composition). In one useful method, the effervescent composition in the form of a tablet is added to an eight ounce glass of water, water in a water bottle, or water in a container. After combining the effervescent composition and water, the mixture can optionally can be stirred or shaken to facilitate dispersion and/or dissolution of the effervescent composition in the water.

### Example 7

A uniform effervescent composition was prepared by blending with mixing the following ingredients: monopotassium phosphate, potassium carbonate, potassium bicarbonate, sorbitol, AVICEL microcrystalline cellulose (FMC Corporation, Philadelphia, Pa.), sodium benzoate, wheat germ oil, and water purification component in the amounts (in percent by weight) set forth in Table 3.

The ingredients were sieved through a 12 mesh screen as necessary. The granulation was then run on a Cadmach tableting press using 21 mm round stainless steel tools. The resulting tablets had an average mass of 2.89 g, an average thickness of 0.221 in and an average hardness of 4.8 kp.

The tablets dissolved in 160 seconds when placed in 8 ounces of 40° F. tap water.

### Example 8

A uniform effervescent composition was prepared by blending with mixing the following ingredients: monopotassium phosphate, potassium carbonate, potassium bicarbonate, AVICEL microcrystalline cellulose (FMC Corporation, Philadelphia, Pa.), sodium benzoate, wheat germ oil, sorbitol, and water purification component in the amounts (in percent by weight) set forth in Table 3.

The ingredients were sieved through a 12 mesh screen as necessary. The granulation was then run on a Cadmach tableting press using 21 mm round stainless steel tools. The resulting tablets had an average mass of 2.91 g, an average thickness of 0.231 in and an average hardness of 4.5 kp.

The tablets dissolved in 85 seconds when placed in 8 ounces of 40° F. tap water.

TABLE 3

| Ingredient | Example 7 | Example 8 |
|---|---|---|
| Monopotassium | 23.8 | 23.8 |
| Phosphate | | |
| Potassium Carbonate | 3.4 | 3.4 |
| Potassium Bicarbonate | 10.2 | 10.2 |
| Microcrystalline | 10.2 | 10.2 |
| Cellulose | | |
| Sodium Benzoate | 1.02 | 1.02 |
| Wheat Germ Oil | 0.5 | 0.5 |
| Sorbitol | 6.8 | 6.8 |
| Water Purification | 44.1 | 44.1 |
| Component | | |

All patents and documents referred to herein are hereby incorporated herein in their entirety. To the extent that there is a conflict, this document controls.

What is claimed is:

1. An effervescent tablet comprising:
an effervescent agent comprising
an acid component selected from the group consisting of an acid salt, an acid anhydride, and combinations thereof, and
a base;
binder; and
lubricant,
the effervescent tablet, when placed in milk, disintegrates to form a milk beverage that is free of noticeable curdling.

2. The tablet of claim 1, wherein the tablet disintegrates in milk having a temperature of less than 50° F. in less than 500 seconds.

3. The tablet of claim 1 further comprising a flavor agent, the flavor agent comprising at least one of strawberry, chocolate, and vanilla.

4. The tablet of claim 1, wherein the acid component is selected from the group consisting of monopotassium phosphate, monocalcium phosphate, potassium bitartrate, acid citrate salt, sodium dihydrogen phosphate, D-glucurono lactone, and combinations thereof.

5. The tablet of claim 1, wherein the effervescent tablet is free of citric acid, tartaric acid, ascorbic acid, fumaric acid, malic acid, and adipic acid.

6. The tablet of claim 1, wherein acid component comprises monopotassium phosphate.

7. The tablet of claim 1 further comprising defatted chocolate.

8. The tablet of claim 1 further comprising wheat germ oil.

9. The tablet of claim 6 further comprising wheat germ oil.

10. The tablet of claim 6 further comprising defatted chocolate.

11. The tablet of claim 6, wherein the effervescent tablet is free of citric acid, tartaric acid, ascorbic acid, fumaric acid, malic acid, and adipic acid.

12. A method of changing the flavor of milk, the method comprising:
combining an effervescent tablet and milk, the effervescent tablet comprising
an effervescent agent comprising
an acid component selected from the group consisting of an acid salt, an acid anhydride, and combinations thereof, and
a base,
a flavor agent,
binder, and
lubricant; and
allowing the tablet to disintegrate in the milk to form a flavored milk beverage that is free of noticeable curdling.

13. The method of claim 12, wherein the milk has a temperature of no greater than 50° F. during the combining.

14. The method of claim 12, wherein the milk has a temperature of at least 100° F. during the combining.

15. The method of claim 12, wherein the acid component comprises monopotassium phosphate.

16. The method of claim 12, wherein the effervescent tablet is free of citric acid, tartaric acid, ascorbic acid, fumaric acid, malic acid, and adipic acid.

17. The tablet of claim 1, wherein the effervescent tablet disintegrates in water to form water that is tasteless.

18. The tablet of claim 17, wherein the acid component is selected from the group consisting of monopotassium phosphate, monocalcium phosphate, potassium bitartrate, acid citrate salt, sodium dihydrogen phosphate, and combinations thereof.

19. The tablet of claim 18, wherein the base is selected from the group consisting of potassium carbonate, potassium bicarbonate, calcium carbonate, magnesium carbonate, zinc carbonate, and combinations thereof.

20. The tablet of claim 17, wherein the base is selected from the group consisting of potassium carbonate, potassium bicarbonate, calcium carbonate, magnesium carbonate, zinc carbonate, and combinations thereof.

21. The tablet of claim 1 further comprising a creamer that includes a milk component, tablet, when placed in a hot aqueous beverage, disintegrating to form a beverage that is free of noticeable coagulation.

22. The tablet of claim 21, wherein the creamer further comprises at least one of hydrogenated coconut oil, sodium caseinate, sodium stearoyl lactylate, and soy lecithin.

23. A method of providing a creamer to a hot beverage, the method comprising:
combining the effervescent tablet of claim 21 with a hot beverage, and
allowing the tablet to disintegrate in the beverage, the resulting beverage being free of noticeable coagulation.

24. The method of claim 23, wherein the hot beverage comprises at least one of coffee and tea.

25. The tablet of claim 1 further comprising a color agent comprising a mixture of red dye, yellow dye and blue dye.

26. The tablet of claim 25, wherein the color agent comprises a mixture of FD&C number 40 red dye, FD&C number 5 yellow dye and FD&C 1 blue dye.
